(19) United States
(12) Patent Application Publication
(10) Pub. No.: US 2024/0196006 A1
(43) Pub. Date: Jun. 13, 2024

(54) MINIMUM PROCESS GRID FOR INTER-PREDICTION-RELATED VIDEO CODING PROCESSES

(71) Applicant: QUALCOMM Incorporated, San Diego, CA (US)

(72) Inventors: Zhi Zhang, Munich (DE); Han Huang, San Diego, CA (US); Vadim Seregin, San Diego, CA (US); Marta Karczewicz, San Diego, CA (US)

(21) Appl. No.: 18/532,889

(22) Filed: Dec. 7, 2023

Related U.S. Application Data
(60) Provisional application No. 63/386,609, filed on Dec. 8, 2022.

(51) Int. Cl. H04N 19/57; H04N 19/132; H04N 19/139; H04N 19/167; H04N 19/176; H04N 19/52; H04N 19/70

(52) U.S. Cl. CPC H04N 19/57; H04N 19/132; H04N 19/139; H04N 19/167; H04N 19/176; H04N 19/52; H04N 19/70

(57) ABSTRACT

A video decoder can be configured to perform motion compensation for a block of video data using a first process grid size; determine a second process grid size for a subsequent inter-prediction-related video coding process, wherein the second process grid size is larger than the first process grid size; determine whether the block of video data has at least one sample that has a different motion vector than at least one other sample in a block of the second process grid size; in response to determining that the block of video data has at least one sample that has the different motion vector than at least one other sample in the block of the second process grid size, perform the subsequent inter-prediction-related video coding process for the block of video data using the second process grid size; and output a decoded version of the block of video data.

This application claims the benefit of U.S. Provisional Patent Application 63/386,609, filed 8 Dec. 2022, the entire content of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

This disclosure describes techniques related to inter prediction in video codecs. More specifically, this disclosure describes techniques related to determining a process grid size for certain inter-prediction-related video coding processes, such as local illumination compensation (LIC) and out-of-picture boundary (OOB) checks.

A process grid or process grid size generally refers to the shape and number of samples that are processed together. For certain inter prediction processes, such as regular motion compensation or affine motion compensation, it may be desirable to utilize relatively small process grids, such as 1×1 or 2×2. For subsequent inter-prediction-related video coding processes, however, the small process grid may be unnecessarily computationally complex or otherwise too small to produce desirable results.

Accordingly, this disclosure describes techniques for configuring a video coder to perform motion compensation for a block of video data using a first process grid size and for a subsequent inter prediction process, perform the subsequent inter-prediction-related video coding process for the block of video data using a second process grid size in response to determining that the block of video data has at least one sample that has a different motion vector than at least one other sample in a block of the second process grid size. By using two different process grid sizes for motion compensation and a subsequent inter-prediction-related video coding process, the techniques of this disclosure may prevent motion vector misalignment and reduce complexity when performing motion compensation and a subsequent inter-prediction-related video coding process.

According to an example of this disclosure, a method of decoding video data includes performing motion compensation for a block of video data using a first process grid size; determining a second process grid size for a subsequent inter-prediction-related video coding process, wherein the second process grid size is larger than the first process grid size; determining whether the block of video data has at least one sample that has a different motion vector than at least one other sample in a block of the second process grid size; in response to determining that the block of video data has at least one sample that has the different motion vector than at least one other sample in the block of the second process grid size, performing the subsequent inter-prediction-related video coding process for the block of video data using the second process grid size; and outputting a decoded version of the block of video data.

According to an example of this disclosure, a device for decoding video data includes one or more memory units configured to store video data and one or more processors implemented in circuitry, coupled to the one or more memory units, and configured to: perform motion compensation for a block of video data using a first process grid size; determine a second process grid size for a subsequent inter-prediction-related video coding process, wherein the second process grid size is larger than the first process grid size; determine whether the block of video data has at least one sample that has a different motion vector than at least one other sample in a block of the second process grid size; in response to determining that the block of video data has at least one sample that has the different motion vector than at least one other sample in the block of the second process grid size, perform the subsequent inter-prediction-related video coding process for the block of video data using the second process grid size; and output a decoded version of the block of video data.

A computer-readable storage medium stores instructions that when executed by one or more processors cause the one or more processors to perform motion compensation for a block of video data using a first process grid size; determine a second process grid size for a subsequent inter-prediction-related video coding process, wherein the second process grid size is larger than the first process grid size; determine whether the block of video data has at least one sample that has a different motion vector than at least one other sample in a block of the second process grid size; in response to determining that the block of video data has at least one sample that has the different motion vector than at least one other sample in the block of the second process grid size, perform the subsequent inter-prediction-related video coding process for the block of video data using the second process grid size; and output a decoded version of the block of video data.

According to an example of this disclosure, a device for decoding video data includes means for performing motion compensation for a block of video data using a first process grid size; means for determining a second process grid size for a subsequent inter-prediction-related video coding process, wherein the second process grid size is larger than the first process grid size; means for determining whether the block of video data has at least one sample that has a different motion vector than at least one other sample in a block of the second process grid size; means for performing the subsequent inter-prediction-related video coding process for the block of video data using the second process grid size in response to determining that the block of video data has the at least one sample that has the different motion vector than the at least one other sample in a block of the second process grid size; and means for outputting a decoded version of the block of video data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 shows an example of affine motion for a block using a six-parameter affine motion model.

FIG. 3 shows an example of affine motion for a block using a four-parameter affine motion model.

FIG. 4 shows an example of a motion vector for luma and chroma blocks for motion compensation.

FIG. 5 shows an example of motion vector for luma and chroma block out-of-boundary (OOB) checking.

FIG. 6 shows an example of a pixel-based OOB checking.

FIG. 7 shows an example of pixel-based local illumination compensation (LIC) reference template sample derivation.

FIG. 8 shows an example of subblock-based OOB checking.

FIG. 9 shows an example of subblock-based LIC reference template sample derivation.

FIG. 10 is a block diagram illustrating an example video encoder that may perform the techniques of this disclosure.

FIG. 11 is a block diagram illustrating an example video decoder that may perform the techniques of this disclosure.

FIG. 12 is a flowchart illustrating an example process for encoding a current block in accordance with the techniques of this disclosure.

FIG. 13 is a flowchart illustrating an example process for decoding a current block in accordance with the techniques of this disclosure.

FIG. 14 is a flowchart illustrating an example process for decoding a current block in accordance with the techniques of this disclosure.

### DETAILED DESCRIPTION

Video coding (e.g., video encoding and/or video decoding) typically involves predicting a block of video data from either an already coded block of video data in the same picture (e.g., intra prediction) or an already coded block of video data in a different picture (e.g., inter prediction). In some instances, the video encoder also calculates residual data by comparing the prediction block to the original block. Thus, the residual data represents a difference between the prediction block and the original block. To reduce the number of bits needed to signal the residual data, the video encoder transforms and quantizes the residual data and signals the transformed and quantized residual data in the encoded bitstream. The compression achieved by the transform and quantization processes may be lossy, meaning that transform and quantization processes may introduce distortion into the decoded video data.

A video decoder decodes and adds the residual data to the prediction block to produce a reconstructed video block that matches the original video block more closely than the prediction block alone. Due to the loss introduced by the transforming and quantizing of the residual data, the first reconstructed block may have distortion or artifacts. One common type of artifact or distortion is referred to as blockiness, where the boundaries of the blocks used to code the video data are visible. To further improve the quality of decoded video, a video decoder can perform one or more filtering operations on the reconstructed video blocks, such as deblocking filtering, sample adaptive offset (SAO) filtering, and adaptive loop filtering (ALF).

This disclosure describes techniques related to inter prediction in video codecs. More specifically, this disclosure describes techniques related to determining a process grid size for certain inter-prediction-related video coding processes, such as local illumination compensation (LIC) and out-of-picture boundary (OOB) checks.

A process grid or process grid size generally refers to the shape and number of samples that are processed together. For certain inter prediction processes, such as regular motion compensation or affine motion compensation, it may be desirable to utilize relatively small process grids, such as 1×1 or 2×2. For subsequent inter-prediction-related video coding processes, however, the small process grid may be unnecessarily computationally complex or otherwise too small to produce desirable results.

Accordingly, this disclosure describes techniques for configuring a video coder perform motion compensation for a block of video data using a first process grid size and for a subsequent inter prediction process, perform the subsequent inter-prediction-related video coding process for the block of video data using a second process grid size in response to determining that the block of video data has at least one sample that has a different motion vector than at least one other sample in a block of the second process grid size. By using two different process grid sizes for motion compensation and a subsequent inter-prediction-related video coding process, the techniques of this disclosure may prevent motion vector misalignment and reduce complexity when performing motion compensation and a subsequent inter-prediction-related video coding process.

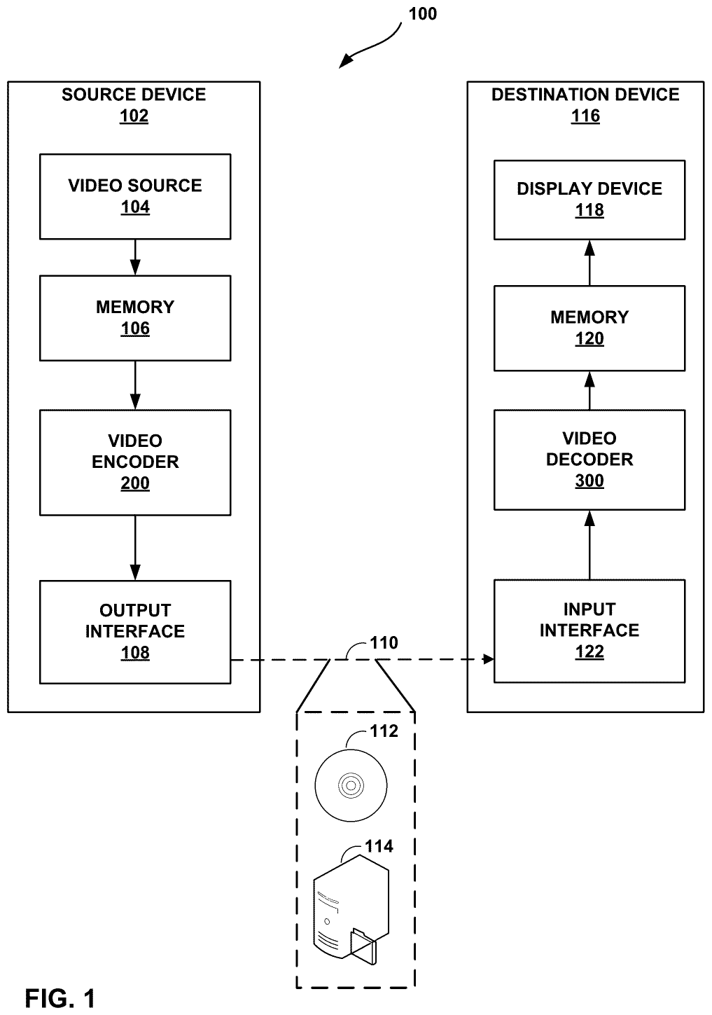

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for determining a minimum process grid for inter-prediction-related video coding processes. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for determining a minimum process grid for inter-prediction-related video coding processes. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that uses inter prediction coding tools.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

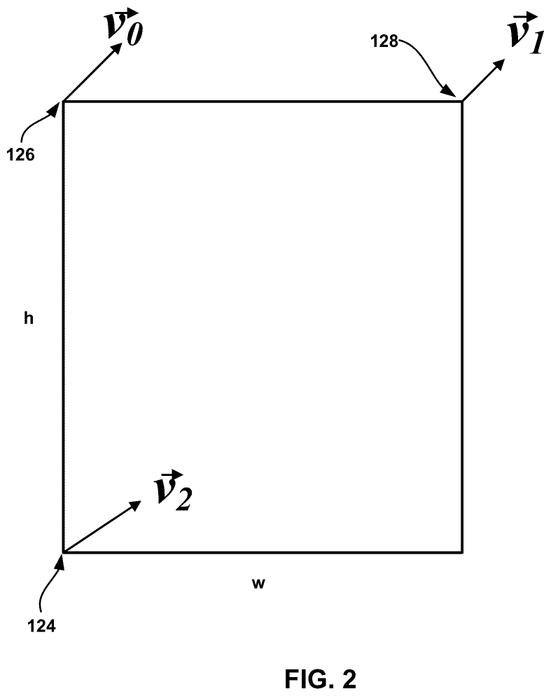

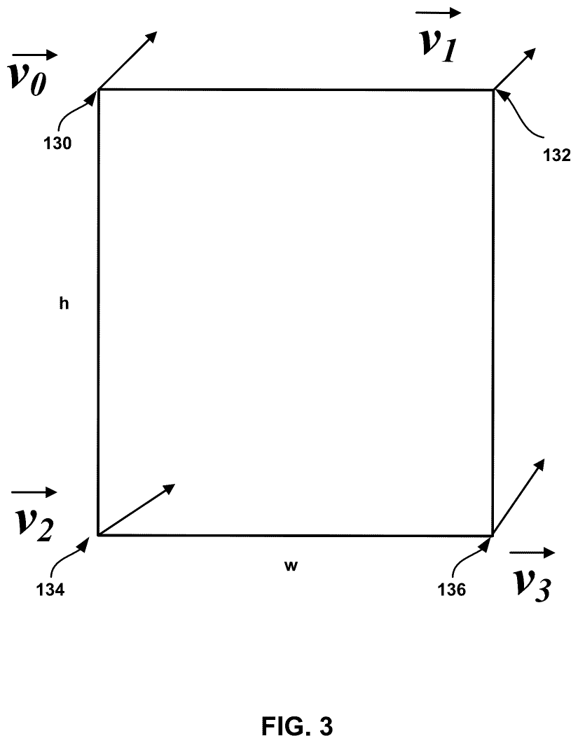

FIGS. 2 and 3 are conceptual diagrams illustrating examples of control point motion vectors (CPMVs) for affine motion compensation. In particular, FIG. 2 depicts current block that is to be predicted using three CPMVs V₀, V₁, and V₂ at three corners (e.g., 124, 126, and 128), while FIG. 3 depicts current block 132 that is to be predicted using four CPMVS V₀, V₁, V₂, and V₃ at four corners (e.g., 130, 132, 134, and 136).

Video encoder 200 and video decoder 300 may be configured to code video data according to an affine motion model. An example of an affine motion model can be expressed as:

$$\{ \begin{matrix}{v}_{x} & = ax + by + e \\ {v}_{y} & = cx + dy + f\end{matrix} \qquad 1 )$$

where (vₓ, v_{y}) represents the motion vector at the coordinate (x, y), and a, b, c, d, e, and f are the six parameters. This affine motion model may be referred to as a 6-parameter affine motion model. In a typical video coder, a picture is partitioned into blocks for block-based coding. The affine motion model for a block can also be described by the three motion vectors \vec{v}₀=(v₀ₓ, v_{0y}), \vec{v}₁=(v₁ₓ, v_{1y}), and \vec{v}₂=(v₂ₓ, v_{2y}) at three different locations that are not in the same line. The three locations are usually referred to as control points, and the three motion vectors are referred to as control-point motion vectors (CPMVs). In the case where the three control-points are at the three corners (e.g., 124, 126, and 128 of FIG. 2) of the block, the affine motion can be described as:

$$\{ \begin{matrix}{v}_{x} = \frac{( {v}_{1 x} - {v}_{0 x} )}{blkW} x + \frac{( {v}_{2 x} - {v}_{0 x} )}{blkH} y + {v}_{0 x} \\ {v}_{y} = \frac{( {v}_{1 y} - {v}_{0 y} )}{blkW} x + \frac{( {v}_{2 y} - {v}_{0 y} )}{blkH} y + {v}_{0 y}\end{matrix} \qquad 2 )$$

wherein blkW and blkH are the width and height of the block.

A simplified 4-parameters affine model (for zoom and rotational motion) may be expressed as:

$$\{ \begin{matrix}{v}_{x} & = ax - by + e \\ {v}_{y} & = bx + ay + f\end{matrix} \qquad 3 )$$

Similarly, the simplified 4-parameters affine model for a block can be described by two CPMVs \vec{v}₀=(v₀ₓ, v_{0y}), \vec{v}₁=(v₁ₓ, v_{1y}) at the two corners of the block. The motion field is then described as:

$$\{ \begin{matrix}{v}_{x} = \frac{( {v}_{1 x} - {v}_{0 x} )}{blkW} x - \frac{( {v}_{1 y} - {v}_{0 y} )}{blkH} y + {v}_{0 x} \\ {v}_{y} = \frac{( {v}_{1 y} - {v}_{0 y} )}{blkW} x + \frac{( {v}_{1 y} - {v}_{0 y} )}{blkH} y + {v}_{0 y}\end{matrix} \qquad 4 )$$

Video encoder 200 and video decoder 300 may be configured to perform subblock based affine motion compensation. Given an affine motion model for a block, video encoder 200 and video decoder 300 may derive different motion vectors for each pixel in the block. Therefore, motion compensation can be performed pixel-by-pixel. However, to reduce the complexity, subblock-based motion compensation is often adopted, where the block is partitioned into multiple subblocks (that have smaller block sizes), and each subblock is associated with one motion vector for motion compensation. The motion vector for each subblock is derived using the representative coordinate of the subblock, which is typically the center position. In some examples, the block may be partitioned into non-overlapping subblocks. In the following discussion, the block width is represented as blkW; block height is represented as blkH; the subblock width is represented as sbW; and subblock height is represented as sbH, such that there are blkH/sbH rows of subblocks and blkW/sbW subblocks in each row. For a 6-parameter affine motion model, the motion vector for the subblock (referred to as subblock motion vector) at iₜₕ row (0<=i<blkW/sbW) and jₜₕ (0<=j<blkH/sbH) column is derived as:

$$\{ \begin{matrix}{v}_{x} = \frac{( {v}_{1 x} - {v}_{0 x} )}{blkW} ( j * sbW + \frac{sbW}{2} ) + \frac{( {v}_{2 x} - {v}_{0 x} )}{blkH} ( i * sbH + \frac{sbH}{2} ) + {v}_{0 x} \\ {v}_{y} = \frac{( {v}_{1 y} - {v}_{0 y} )}{blkW} ( j * sbW + \frac{sbW}{2} ) + \frac{( {v}_{2 y} - {v}_{0 y} )}{blkH} ( i * sbH + \frac{sbH}{2} ) + {v}_{0 y}\end{matrix} \qquad 5 )$$

Video encoder 200 and video decoder 300 may be configured to perform prediction refinement with optical flow (PROF). After the sub-block based affine motion compensation is performed, the prediction signal can be refined by adding an offset derived based on the pixel-wise motion and the gradient of the prediction signal. The offset at location (m, n) can be calculated as:

ΔI(m,n)=gₓ(m,n)*Δvₓ(m,n)+g_{y}(m,n)*Δv_{y}(m,n)

wherein gₓ(m, n) is the horizontal gradient and g_{y} (m, n) is the vertical gradient of the prediction signal, respectively. Δvₓ(m, n) and Δv_{y} (m, n) are the differences in the x and y components between the motion vector calculated at location pixel location (m, n) and the subblock motion vector. The coordinate of the top-left sample of the subblock can be considered to be (0,0), such that the center of the subblock is

$$( \frac{sbW}{2} , \frac{sbH}{2} ) .$$

Given the affine motion parameters a, b, c, and d, Δvₓ(m, n) and Δv_{y} (m, n) can be derived as:

$$Δ {v}_{x} ( m , n ) = a * ( m - \frac{sbW}{2} ) + b * ( n - \frac{sbH}{2} )$$

$$Δ {v}_{y} ( m , n ) = c * ( m - \frac{sbW}{2} ) + d * ( n - \frac{sbH}{2} )$$

In the control-points based affine motion model, the affine motion parameters a, b, c, and d are calculated from the CPMVs as:

$$a = \frac{( {v}_{1 x} - {v}_{0 x} )}{blkW}$$

$$b = \frac{( {v}_{2 x} - {v}_{0 x} )}{blkH}$$

$$c = \frac{( {v}_{1 y} - {v}_{0 y} )}{blkW}$$

$$d = \frac{( {v}_{2 y} - {v}_{0 y} )}{blkH}$$

Video encoder 200 and video decoder 300 may be configured to perform overlapped block motion compensation (OBMC). When OBMC is applied, the top and left boundary pixels of a CU are refined using motion information of a neighboring block with a weighted prediction as described in JVET-L0101.

Video encoder 200 and video decoder 300 may configured to not apply OBMC under certain conditions. Such conditions includes, for example, when OBMC is disabled at an SPS level, when a current block has an intra mode or intra block copy (IBC) mode, when LIC is applied to a current block, and when a current luma block area is smaller or equal to 32.

Video encoder 200 and video decoder 300 may be configured to perform a subblock-boundary OBMC by applying the same blending to the top, left, bottom, and right subblock boundary pixels using motion information of neighboring subblocks. OBMC may be enabled for the subblock-based coding tools, such as affine AMVP modes, affine merge modes and subblock-based temporal motion vector prediction (SbTMVP), and subblock-based bilateral matching.

When OBMC mode is used in combined intra and inter prediction (CIIP) mode with luma mapping with chroma scaling (LMCS), video encoder 200 and video decoder 300 may perform inter blending prior to LMCS mapping of inter samples. LMCS is applied to blended inter samples which are combined with LMCS applied intra samples in CIIP mode,

$${Inter}_{predY}^{′} = \frac{( 128 - {w}_{1} ) \times {Inter}_{predY} + {w}_{1} \times {OBMC}_{predY}}{128}$$

$$PredY = \frac{( 4 - {w}_{0} ) \times FwdMap ( {Inter}_{predY}^{′} ) + {w}_{0} \times {Intra}_{predY}}{4} ,$$

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

Video encoder 200 and video decoder 300 may be configured to perform LIC. LIC is an inter prediction technique to model local illumination variation between a current block and a corresponding prediction block as a function of the variation between a current block template and a reference block template. The parameters of the function may be denoted by a scale α and an offset β, which forms a linear equation (α*p[x]+β) to compensate for illumination changes, where p[x] is a reference sample pointed to by a motion vector at a location x on a reference picture. As a and R can be derived based on a current block template and a reference block template, no signaling overhead is required, except that an LIC flag may be signaled for AMVP mode to indicate the use of LIC.

The LIC proposed in JVET-O0066 is used for uni-prediction inter CUs with the some modifications. For example, intra neighbor samples may be used in LIC parameter derivation, and LIC may disabled for blocks with less than 32 luma samples. Additionally, for both non-subblock and affine modes, LIC parameter derivation may be performed based on the template block samples corresponding to the current CU, instead of partial template block samples corresponding to first top-left 16×16 unit.

When performing LIC, video encoder 200 and video decoder 300 may be configured to generate samples of the reference block template by using motion compensation with the block motion vector without rounding to integer-pel precision.

Video encoder 200 and video decoder 300 may be configured to perform multi-hypothesis prediction (MHP). In the multi-hypothesis inter prediction mode (JVET-M0425), one or more additional motion-compensated prediction signals are signaled, in addition to the conventional bi prediction signal. The resulting overall prediction signal is obtained by sample-wise weighted superposition. With the bi prediction signal p_{bi} and the first additional inter prediction signal/hypothesis h₃, the resulting prediction signal p₃ is obtained as follows:

p₃=(1−α)p_{bi}+αh₃

The weighting factor α is specified by the new syntax element add_hyp_weight_idx, according to the following mapping:

| add_hyp_weight_idx | α |
|---|---|
| 0 | ¼ |
| 1 | −⅛ |

Analogously to above, more than one additional prediction signal may be used. The resulting overall prediction signal is accumulated iteratively with each additional prediction signal.

pₙ₊₁=(1−αₙ₊₁)pₙ+αₙ₊₁hₙ₊₁

The resulting overall prediction signal is obtained as the last pₙ (i.e., the pₙ having the largest index n). Within this EE, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signaling modes.

For inter AMVP mode, video encoder 200 and video decoder 300 may be configured to only apply MHP if non-equal weight in BCW is selected in bi-prediction mode. A combination of MHP and BDOF may also be possible. In such cases, video encoder 200 and video decoder 300 may be configured to only apply BDOF to the bi-prediction signal part of the prediction signal, such as the ordinary first two hypotheses.

Video encoder 200 and video decoder 300 may be configured to perform enhanced bi-directional motion compensation with out-of-boundary (OOB) prediction samples. In bi-directional motion compensation, the OOB prediction samples are discarded and only the non-GOB predictors, when available, are used to generate the final predictor. Specifically, let Pos_x_{i,j} and Pos_y_{i,j} denote the position of one prediction sample in one current block; Mv_x_{i,j}^{Lx} and Mv_y_{i,j}^{Lx} (x=0,1) denote the motion vector of the current block; and Pos_{LeftBdry}, POS_{RightBdry}, POS_{TopBdry} and PoS_{BottomBdry} represent the positions of four boundaries of the picture. A prediction sample may be regarded as GOB when at least one of the following conditions is satisfied:

(Pos_x_{i,j}+Mv_x_{i,j}^{Lx})>(Pos_{RightBdry}+half_pixel),

(Pos_x_{i,j}+Mv_x_{i,j}^{Lx})<(Pos_{LeftBdry}−half_pixel),

(Pos_y_{i,j}+Mv_y_{i,j}^{Lx})>(Pos_{BottomBdry}+half_pixel),

(Pos_y_{i,j}+Mv_y_{i,j}^{Lx})<(POS_{TopBdry}−half_pixel)

where half_pixel is equal to 8 that represents the half-pel sample distance in the 1/16-pel sample precision.

After examining the OOB condition for each sample, video encoder 200 and video decoder 300 may generate the final prediction samples of one bi-directional block as follows:

```
If P_{i,j}^{L0} is OOB and P_{i,j}^{L1} is non-OOB
    P_{i,j}^{final} = P_{i,j}^{L1}
else if P_{i,j}^{L0} is non-OOB and P_{i,j}^{L1} is OOB
    P_{i,j}^{final} = P_{i,j}^{L0}
else
  P_{i,j}^{final} = (P_{i,j}^{L0} + P_{i,j}^{L1} + 1) >> 1
```

Video encoder 200 and video decoder 300 may also apply an OOB checking process when BCW is enabled.

This sample-adaptive bi-prediction process may only apply to prediction units for which at least a reference bock is first detected as partially or entirely out-of-bounds. Thus, a block-level OOB criteria is first checked. If both prediction blocks are non-GOB, then the usual bi-prediction process may be performed.

Existing techniques may have potential problems. In VVC and the current version of the enhanced compression model (ECM), it is possible that an inter predicted coding block is partitioned into several subblocks and each subblock has a motion vector. In some cases, the same partition of subblocks applies to both luma and chroma blocks, and the chroma subblock uses the same motion vector as a corresponding luma subblock. However, it is possible to have different subblock partitions for luma and chroma. For example, for an 8×8 affine predicted block with a format of 4:2:0, the luma block may be partitioned into four 4×4 subblocks, whereas the chroma block may be kept the same as the original 4×4 chroma block. In this case, each luma subblock has a motion vector, whereas the chroma block has a motion vector that is derived as the average of two motion vectors of the corresponding luma subblocks at the top-left and bottom-right positions.

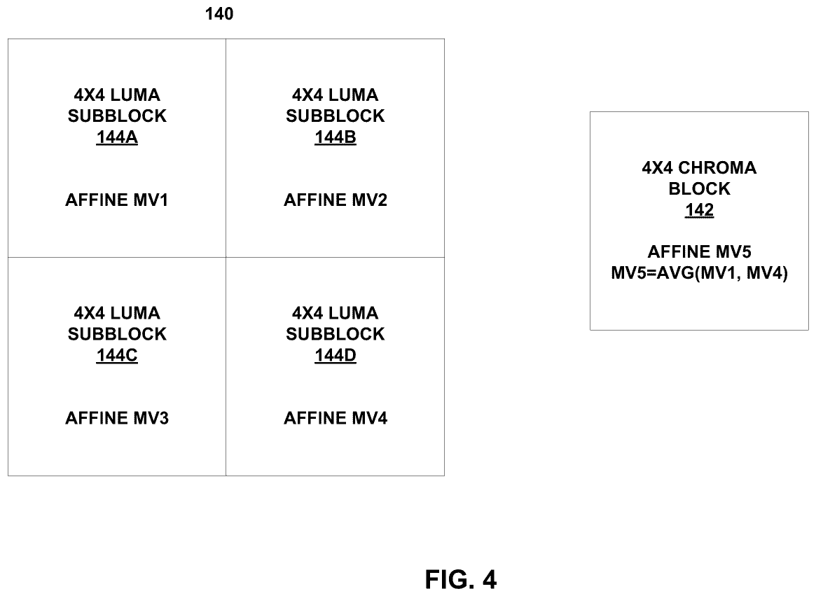

FIG. 4 shows an example of an 8×8 luma block 140 and a corresponding 4×4 chroma block 142. In the example of FIG. 4, the affine motion vector (MV5) of 4×4 chroma block 142 is derived as the average of MV1 and MV4 of 4×4 luma subblock 144A and 4×4 luma subblock 144D, respectively. 4×4 luma subblock 144B and 4×4 luma subblock 144C have motion vectors MV2 and M3 respectively, but in the example of FIG. 4, those MVs are not use to determine MV5.

MV1 to MV4 are used in a motion compensation process to derive the luma prediction block. MV5 is used in the motion compensation process to derive the chroma prediction block. However, MV1 to MV5 may also be used in other processes, for example, to perform an OOB pixel check. In the current ECM, instead of using the chroma MV5 to perform the OOB chroma pixel check, whether the chroma pixel is OOB or not is determined by using the corresponding luma motion vector.

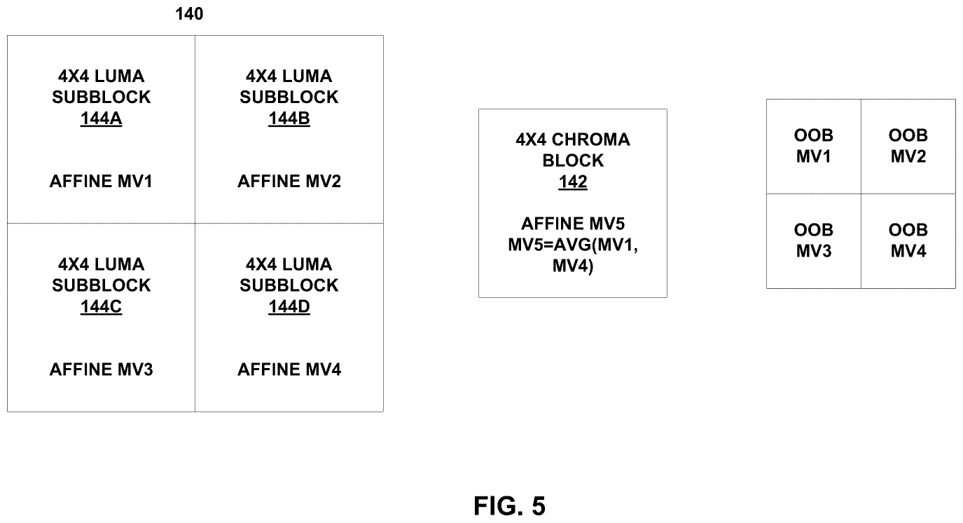

FIG. 5. shows the motion vector that is used for OOB check for luma block 140 and chroma block 142 of FIG. 4. FIG. 5 shows an example of a misalignment for a motion compensation processes between a luma block and a chroma block. It also shows a misalignment of the motion vector that is used to check for an OOB chroma pixels and the motion vector used to perform motion compensation for a chroma block. When the subblock partition is pixel based, e.g., each pixel has its motion vector, the misalignment problem can also happen for other process, such as when deriving LIC reference template samples.

To address the issues introduced above, this disclosure describes techniques to determine a minimum process grid for a video coding process such as motion compensation, OOB, and LIC reference template sample derivation. When the minimum process grid of a process is determined, various techniques are disclosed to derive a motion vector to be used for the process.

According to techniques of this disclosure, video encoder 200 and video decoder 300 may be configured to perform a process using a pixel-based motion vector. In such an example, when a coding block has at least one pixel with a motion vector that is different than other pixel(s), the minimum process grid of a process is determined to be 1×1, referred to as a pixel-based process because a motion vector of each pixel is used. The process can be motion compensation, OOB check, LIC reference template sample derivation. A coding block can be a luma coding block and a chroma coding block.

For pixel-based motion compensation, video encoder 200 and video decoder 300 may be configured to derive a prediction block using pixel-based prediction, where each pixel has its motion vector. For a pixel-based OOB check, video encoder 200 and video decoder 300 determines if a pixel is GOB or not by checking whether the motion vector of the pixel points to a position in a reference picture that is out of the reference picture boundary or not.

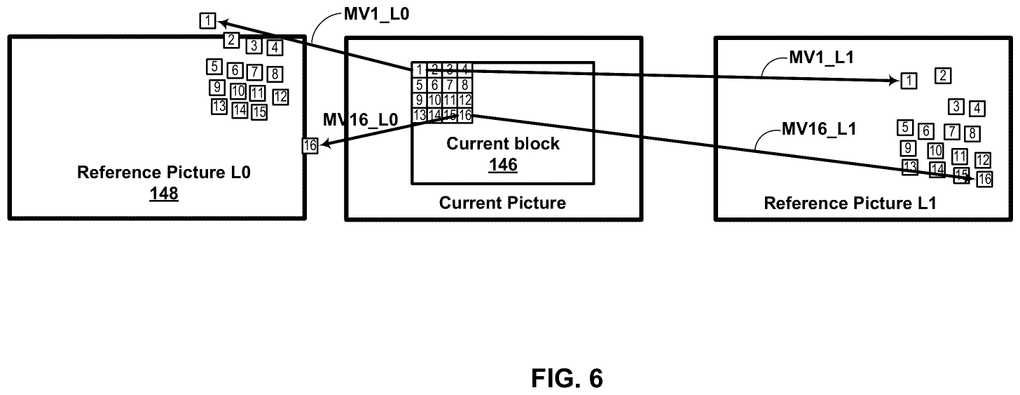

FIG. 6 shows an example where the motion vector for motion compensation is also used to perform an OOB check, e.g., to decide if a pixel is GOB or not. In the example of FIG. 6, video decoder 300 performs an OOB check for each pixel of current block 146 in using a motion compensation motion vector of the pixel. In the example of FIG. 6, pixel 16 of current block 146 has a bi-motion vectors, but the L0 motion vector (MV16_L0) points outside of reference picture 148. Therefore, video decoder 300 may be configured to predict pixel 16 using only MV16_L1.

For pixel-based LIC reference template sample derivation, video encoder 200 and video decoder 300 derive a 1×M LIC reference template sample block above the current block using the motion vector of the corresponding boundary pixel inside the current block, and derive a N×1 LIC reference template sample block to the left of the current block using the corresponding motion vector of a boundary pixel inside the current block. M and N represent the LIC template size of the above and left of the current block, respectively.

In some examples, instead of using a motion vector of one boundary pixel video encoder 200 and video decoder 300 may derive the LIC reference template sample using an average of a subset of the pixels along the current block boundary to derive the motion vector.

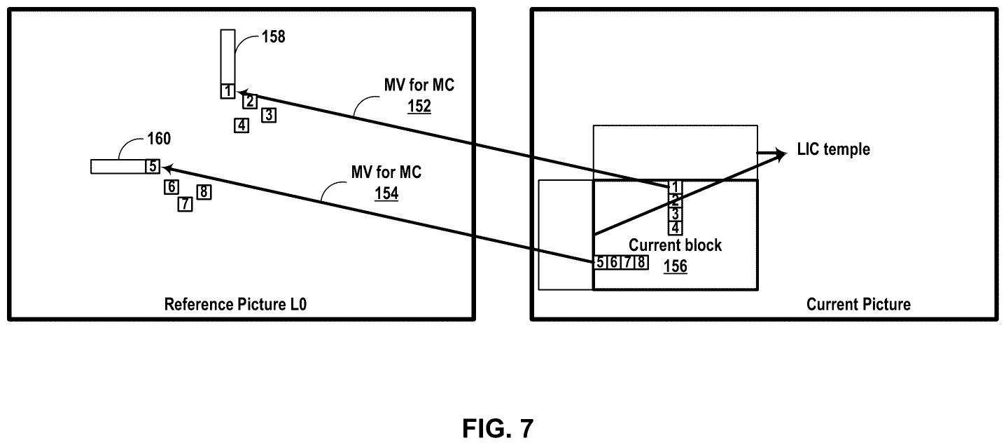

FIG. 7 shows an example where motion vectors 152 and 154 are used for motion compensation of current block 156 and used to derive the above and left reference template sample blocks, 158 and 1160 respectively, 154 for LIC is the same as the motion vector that is used for motion compensation of pixels 1 and 5 respectively.

In some examples, video encoder 200 and video decoder 300 may apply pixel-based motion compensation to derive a template block for a decoder side motion refinement process. The decoder side motion refinement process may, for example, be template matching or bilateral matching based.

For a bilateral matching refinement process, video encoder 200 and video decoder 300 perform a pixel-based motion compensation to derive a template block in reference pictures L0 and L1, respectively, and to derive a refined motion by minimizing the difference between the two templates in L0 and L1.

For a template matching refinement process, video encoder 200 and video decoder 300 may perform pixel-based motion compensation to derive a reference template block to the left of the current block or above the current block in reference picture(s) and derive a refined motion by minimizing the difference between the reference template block and the template block of the current block in current picture.

In one example, video encoder 200 and video decoder 300 may apply pixel-based motion compensation to derive a template block for a decoder side motion vector predictor (MVP) reordering process. The decoder side MVP reordering process may, for example, be template matching or bilateral matching based.

For bilateral matching MVP reordering process, video encoder 200 and video decoder 300 may perform a pixel-based motion compensation to derive a template block in reference picture L0 and L1, respectively, and to prioritize a MVP which has a smaller difference between two templates on L0 and L1.

For a template matching MVP reordering process, video encoder 200 and video decoder 300 may perform a pixel-based motion compensation to derive a reference template block to the left of the current block or above the current block in reference picture(s) and to prioritize an MVP which has a smaller difference between the reference template block and the template block of the current block in current picture.

According to techniques of this disclosure, video encoder 200 and video decoder 300 may be configured to perform a process using a derived motion vector of a subblock area. In some examples, when a coding block has at least one pixel with a motion vector that is different to other pixel(s), video encoder 200 and video decoder 300 may determine the minimum process grid of a process to be subblock based and perform the subblock process using a motion vector derived from a subblock. In the subblock, at least one pixel may have a motion vector that is different than other pixel(s) used by the motion compensation process. The process may, for example, be an OOB check or an LIC reference template sample derivation. A coding block may include a luma coding block and a chroma coding block.

When the process is a motion compensation process, and there is at least one pixel has a difference motion vector compares to other pixels, the block is divided to several subblocks and each subblock predictor is derived by motion compensation using the subblock motion vector.

According to techniques of this disclosure, video encoder 200 and video decoder 300 may be configured to perform an OOB pixel check process using a derived motion vector.

In this example, when at least one pixel in a subblock has a motion vector that is used for motion compensation process is different to other pixel(s) in the subblock, the OOB pixel check process of the subblock uses a derived motion vector.

In one example, give a W×H coding block do pixel-based (affine) motion compensation, for each pixel there is a motion vector to derive the prediction pixel. A sbOobW×sbOobH oobSubblock of the coding block check all reference pixel within the oobSubblock to be OOB pixel or not OOB pixel by using a derived motion vector. At least one pixel in the oobSubblock has a motion vector for motion compensation is different to other pixel(s) in the oobSubblock. Wherein, 1<sbOobW≤W and 1<sbOobH≤H.

In one example, given a W×H coding block is partitioned to several sbW×sbH subblocks and do subblock-based motion compensation (MC), for each subblock there is a motion vector to derive the prediction subblock. A sbOobW×sbOobH oobSubblock of the coding block check all reference pixel with in the oobSubblock to be OOB pixel or not OOB pixel by using a derived motion vector. At least one pixel in the oobSubblock has a motion vector for motion compensation (MC) is different to other pixel(s) in the oobSubblock. Wherein, 1<sbOobW≤W and 1<sbOobH≤H. The partition of oobSubblock is different compared to the partition of MC subblock.

In one example, the derived motion vector is same as one motion vector that is used for MC of one pixel, e.g., a pixel at top-left of the oobSubblock.

In one example, the derived motion vector is an average of a subset of motion vectors that are used for MC of a subset of pixels within the oobSubblock.

In one example, the oobSubblock is a chroma block, the derived motion vector is same as one motion vector that is used for MC of one corresponding luma pixel, e.g., a luma pixel corresponding to the top-left chroma pixel of the oobSubblock.

In one example, the oobSubblock is a chroma block, the derived motion vector is an average of a subset of motion vectors that are used for MC of the corresponding luma pixels.

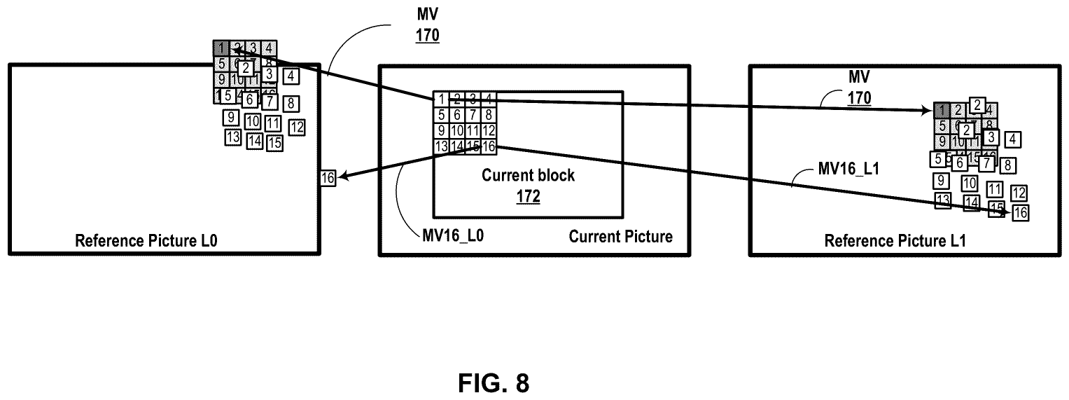

FIG. 8 shows an example where motion vector 170 is used to determine if a pixel is OOB or not. Motion vector 170 is the motion vector for pixel 1, i.e., the top-left pixel of current block 172. Pixels in reference picture L0 and L1 represent OOB checking in reference pictures, whereas the solid white pixels represent the prediction pixels. It can be noticed that pixel 1 has same prediction pixel and pixel for OOB check.

According to techniques of this disclosure, video encoder 200 and video decoder 300 may be configured to perform an LIC reference template sample derivation process using a derived motion vector. In some examples, when at least one pixel in a subblock has a motion vector used for a MC process that is different than the motion vectors of other pixel(s) in the subblock, video encoder 200 and video decoder 300 may perform the LIC reference template sample derivation process of the subblock using a derived motion vector.

In one example, for a W×H coding block, video encoder 200 and video decoder 300 may configured to perform pixel-based (affine) MC. For each pixel, video encoder 200 and video decoder 300 may use a motion vector to derive the prediction pixel. A sbLicW×1 (at top block boundary) or 1×sbLicH (at left block boundary) licSubblock of the coding block may be used to derive sbLicW×P or Q×sbLicH LIC reference template samples by using a derived motion vector to the top and left of the current block respectively. At least one pixel in the licSubblock has a motion vector for motion compensation that is different than other pixel(s) in the licSubblock. Wherein, 1<sbLicW≤W and 1<sbLicH≤H.

In one example, a W×H coding block may be partitioned into several sbW×sbH subblocks, and video encoder 200 and video decoder 300 may perform subblock-based motion compensation. For each subblock, video encoder 200 and video decoder 300 may use a motion vector to derive the prediction subblock. A 1×sbLicH (at left block boundary) or sbLicW×1 (at top block boundary) licSubblock of the coding block may be used to derive sbLicW×P or Q×sbLicH LIC reference template samples by using a derived motion vector to the top and left of the current block respectively. At least one pixel in the licSubblock has a motion vector for MC is different to other pixel(s) in the licSubblock. Wherein, 1<sbLicW≤W and 1<sbLicH≤H. P and Q represent the height and width of a LIC reference temple to the top and left of the current block, respectively.

In some examples, the derived motion vector may be the same as one of the motion vectors that is used for MC of one pixel, e.g., a pixel at top-left of the licSubblock. In some examples, the derived motion vector may be an average of a subset of motion vectors that are used for MC of a subset of pixels, with the pixels being within the licSubblock or being within a bigger subblock M×sbLicH (at left block boundary) or sbLicW×N (at top block boundary). In some examples, the licSubblock is a chroma block. The derived motion vector may be the same as one of the motion vectors used for motion compensation of one corresponding luma pixel, e.g., a luma pixel corresponding to the top-left chroma pixel of the licSubblock. In some examples, the licSubblock may be a chroma block. The derived motion vector may be an average of a subset of motion vectors that are used for motion compensation of the corresponding luma pixels.

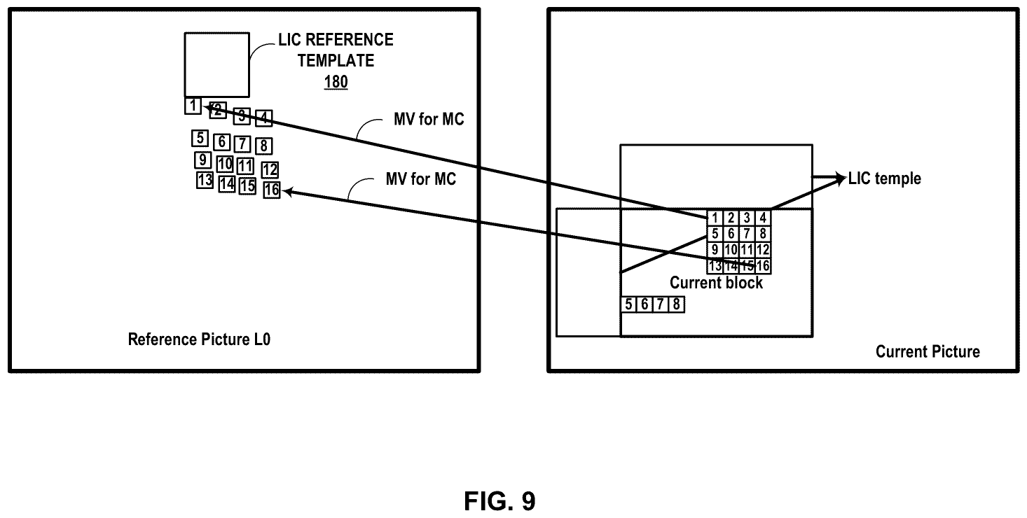

FIG. 9 shows an example where a LIC reference template 180 is derive by a subset of pixels 1 to 16. In the example, the licSubblock dimensions are sbLicW=4 and P=4. The derived motion vector to derive the LIC reference template may be the same as the motion vector used for MC of pixel 1.

According to techniques of this disclosure, video encoder 200 and video decoder 300 may be configured to determine a minimum process grid. In some examples, the minimum process grid is predetermined as M×N for a process, e.g., M is equal to 4 and N is equal to 4. The aforementioned values of sbLicW, sbLicH, sbOobW, sbOobH may be derived based on the predetermined value of M and N and the current block dimension W and H.

In some examples, video encoder 200 may signal the minimum process grid to video decoder 300 as a high-level syntax value such as SPS, PPS, picture header or slice header to each of the process such as MC, LIC, OOB. In some examples, the minimum process grid for all processes such as MC, LIC and OOB may be same. For example, all process are pixel based. In some examples, the minimum process grid for motion compensation may be pixel based, whereas LIC and OOB has a minimum process grid of M×N, wherein M>1 and/or N>1.

In some examples, the minimum process grid for a process may be block size dependent. For example, a pixel-based process may be applied when a coding block has a dimension W×H where W is equal or less than a threshold, H is equal or less than a threshold, or W*H is equal or less than a threshold. For example, a subblock-based process may be applied when a coding block has a dimension W×H where W is equal or less than a threshold, H is equal or less than a threshold, or W*H is equal or less than a threshold.

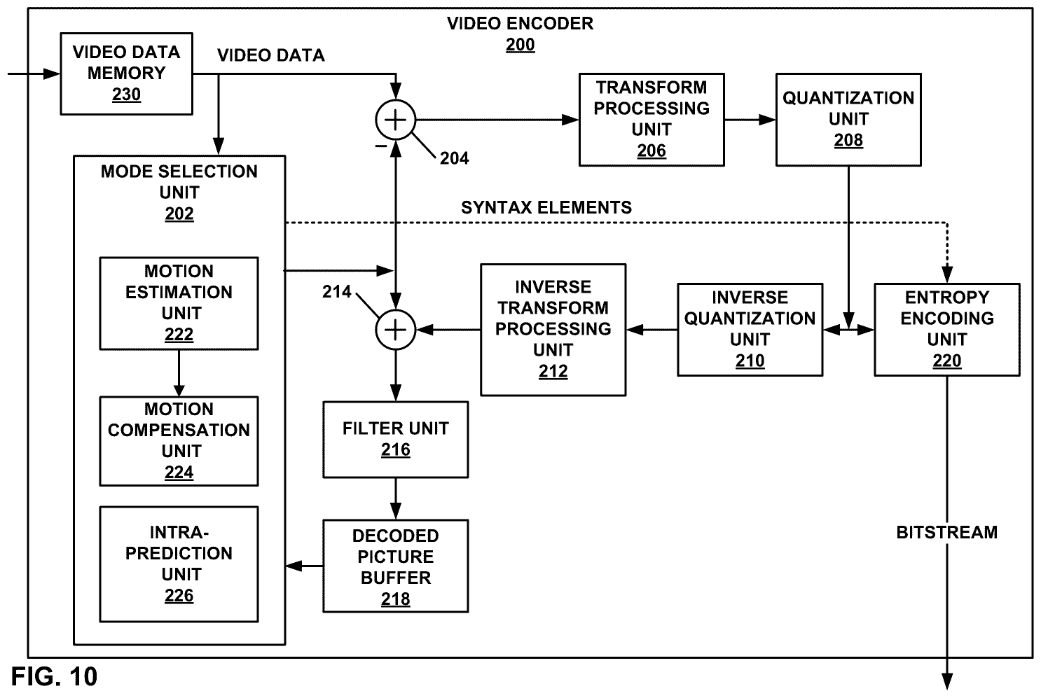

FIG. 10 is a block diagram illustrating an example video encoder 200 that may perform the techniques of this disclosure. FIG. 10 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 10, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 10 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine that a block of video data is coded using an inter-prediction-related video coding process; determine a minimum process grid for the inter-prediction-related video coding process; and determine a motion vector for the block of video data based on the minimum process grid.

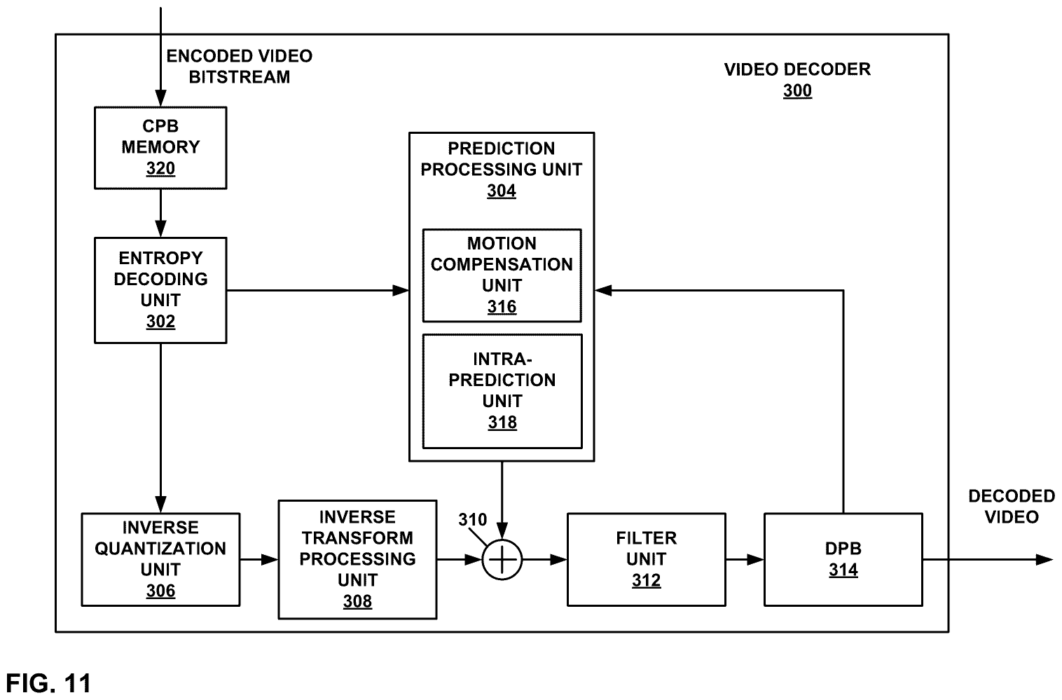

FIG. 11 is a block diagram illustrating an example video decoder 300 that may perform the techniques of this disclosure. FIG. 11 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 11, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

Prediction processing unit 304, e.g., motion compensation unit 316, may perform one or more techniques of this disclosure. For example, prediction processing unit 304 perform motion compensation for a block of video data using a first process grid size; determine a second process grid size for a subsequent inter-prediction-related video coding process, wherein the second process grid size is larger than the first process grid size; and in response to determining that the block of video data has at least one sample that has a different motion vector than at least one other sample in a block of the second process grid size, perform the subsequent inter-prediction-related video coding process for the block of video data using the second process grid size.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 11 are illustrated to assist with understanding the operations performed by video decoder 300. The units may be implemented as fixed-function circuits, programmable circuits, or a combination thereof. Similar to FIG. 10, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 10).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 10). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine that a block of video data is coded using an inter-prediction-related video coding process; determine a minimum process grid for the inter-prediction-related video coding process; and determine a motion vector for the block of video data based on the minimum process grid.

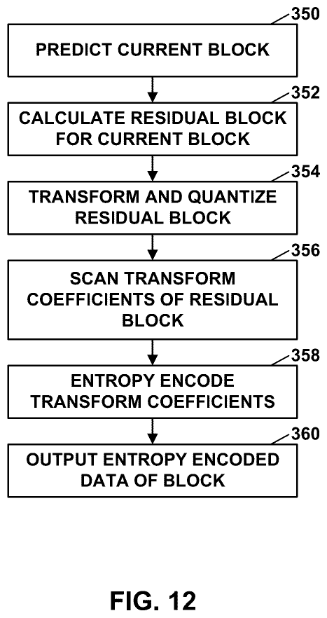

FIG. 12 is a flowchart illustrating an example process for encoding a current block in accordance with the techniques of this disclosure. The current block may be or include a current CU. Although described with respect to video encoder 200 (FIGS. 1 and 10), it should be understood that other devices may be configured to perform a process similar to that of FIG. 12.

In this example, video encoder 200 initially predicts the current block (350). For example, video encoder 200 may form a prediction block for the current block. As part of performing prediction for the block, video encoder 200 may determine a minimum process grid for an inter-prediction-related video coding process as described herein. Video encoder 200 may then calculate a residual block for the current block (352). To calculate the residual block, video encoder 200 may calculate a difference between the original, unencoded block and the prediction block for the current block. Video encoder 200 may then transform the residual block and quantize transform coefficients of the residual block (354). Next, video encoder 200 may scan the quantized transform coefficients of the residual block (356). During the scan, or following the scan, video encoder 200 may entropy encode the transform coefficients (358). For example, video encoder 200 may encode the transform coefficients using CAVLC or CABAC. Video encoder 200 may then output the entropy encoded data of the block (360).

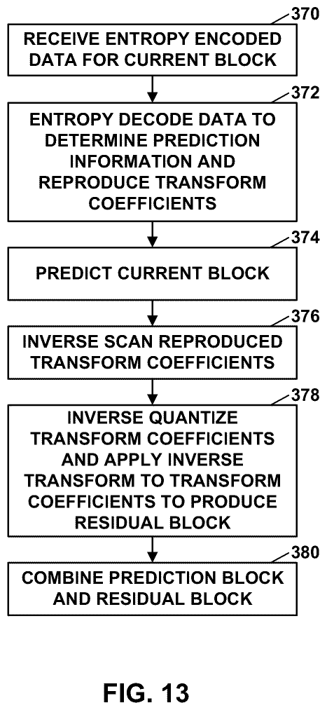

FIG. 13 is a flowchart illustrating an example process for decoding a current block of video data in accordance with the techniques of this disclosure. The current block may be or include a current CU. Although described with respect to video decoder 300 (FIGS. 1 and 11), it should be understood that other devices may be configured to perform a process similar to that of FIG. 13.

Video decoder 300 may receive entropy encoded data for the current block, such as entropy encoded prediction information and entropy encoded data for transform coefficients of a residual block corresponding to the current block (370). Video decoder 300 may entropy decode the entropy encoded data to determine prediction information for the current block and to reproduce transform coefficients of the residual block (372). Video decoder 300 may predict the current block (374), e.g., using an intra- or inter-prediction mode as indicated by the prediction information for the current block, to calculate a prediction block for the current block. As part of performing prediction for the block, video decoder 300 may determine a minimum process grid for an inter-prediction-related video coding process as described herein. Video decoder 300 may then inverse scan the reproduced transform coefficients (376), to create a block of quantized transform coefficients. Video decoder 300 may then inverse quantize the transform coefficients and apply an inverse transform to the transform coefficients to produce a residual block (378). Video decoder 300 may ultimately decode the current block by combining the prediction block and the residual block (380).

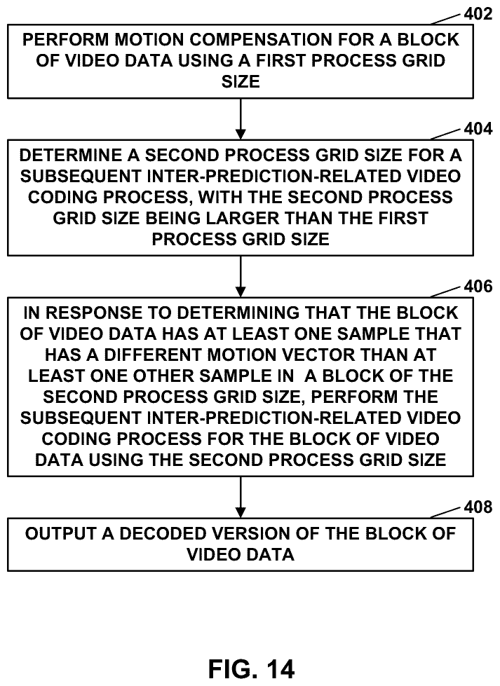

FIG. 14 is a flowchart illustrating an example process for decoding a current block of video data in accordance with the techniques of this disclosure. The current block may be or include a current CU. Although described with respect to video decoder 300 (FIGS. 1 and 11), it should be understood that other devices may be configured to perform a process similar to that of FIG. 14. In some examples, video encoder 200 (FIGS. 1 and 10) may perform some or all of the aspects of FIG. 14 as part of a video encoding process. Video encoder 200 may, for example, determine the techniques of FIG. 14 as part of determining how to encode a block of video data.

In the example of FIG. 14, video decoder 300 performs motion compensation for a block of video data using a first process grid size (402). In some examples, the first process grid size may be as small as 1×1.

Video decoder 300 determines a second process grid size for a subsequent inter-prediction-related video coding process, with the second process grid size being larger than the first process grid size (404). Video decoder 300 may, for example, determine the second process grid size by receiving signaling indicating the second process grid size, deriving the second process grid size without explicit signaling, or by using a fixed second process grid size. The subsequent inter-prediction-related video coding process may, for example, be local illumination compensation, an out-of-boundary check, or some other such process.

In response to determining that the block of video data has at least one sample that has a different motion vector than at least one other sample in a block of the second process grid size, video decoder 300 performs the subsequent inter-prediction-related video coding process for the block of video data using the second process grid size (406).

Video decoder 300 outputs a decoded version of the block of video data (408). Video decoder 300 may, for example, display a picture of decoded video data that includes the decoded version of the block store for transmission or later display a picture of decoded video data that includes the decoded version of the block, or store for use in decoding subsequent pictures of video data a picture of decoded video data that includes the decoded version of the block.

The following numbered clauses illustrate one or more aspects of the devices and techniques described in this disclosure.

Clause 1A: A method of coding video data, the method comprising: determining that a block of video data is coded using an inter-prediction-related video coding process; determining a minimum process grid for the inter-prediction-related video coding process; and determining a motion vector for the block of video data based on the minimum process grid.

Clause 2A: The method of clause 1A, wherein the inter-prediction-related video coding process comprises one of motion compensation local illumination compensation, or an out-of-boundary check.

Clause 3A: The method of clause 1A or 2A, wherein determining the minimum process grid for the inter-prediction-related video coding process comprises: in response to determining that the block has at least one sample that has a different motion vector than at least one other sample in the block, determining that the minimum process grid is equal to 1×1.

Clause 4A: The method of clause 1A or 2A, wherein determining the minimum process grid for the inter-prediction-related video coding process comprises: in response to determining that the block has at least one sample that has a different motion vector than at least one other sample in the block, determining that the minimum process grid is sub-block based.

Clause 5A: The method of clause 4A, wherein determining that the minimum process grid is sub-block based comprises determining that the minimum process grid is equal to a size of a subblock.

Clause 6A: The method of clause 1A or 2A, wherein determining the minimum process grid for the inter-prediction-related video coding process comprises receiving one or more syntax elements in a bitstream of the video data, wherein the one or more syntax element indicate a size of the minimum process grid.

Clause 7A: The method of clause 1A or 2A, wherein determining the minimum process grid for the inter-prediction-related video coding process comprises determining the minimum process grid for the inter-prediction-related video coding process based on a size of the block.

Clause 8A: The method of clause 1A or 2A, wherein determining the minimum process grid for the inter-prediction-related video coding process comprises determining the minimum process grid for the inter-prediction-related video coding process based on the inter-prediction-related video coding process.

Clause 9A: The method of any of clauses 1A-8A, wherein coding comprises decoding.

Clause 10A: The method of any of clauses 1A-8A, wherein coding comprises encoding.

Clause 11A: A device for coding video data, the device comprising one or more means for performing the method of any of clauses 1A-8A.

Clause 12A: The device of clause 11A, wherein the one or more means comprise one or more processors implemented in circuitry.

Clause 13A: The device of any of clauses 11A and 12A, further comprising a memory to store the video data.

Clause 14A: The device of any of clauses 11A-13A, further comprising a display configured to display decoded video data.

Clause 15A: The device of any of clauses 11A-14A, wherein the device comprises one or more of a camera, a computer, a mobile device, a broadcast receiver device, or a set-top box.

Clause 16A: The device of any of clauses 11A-15A, wherein the device comprises a video decoder.

Clause 17A: The device of any of clauses 11A-16A, wherein the device comprises a video encoder.

Clause 18A: A computer-readable storage medium having stored thereon instructions that, when executed, cause one or more processors to perform the method of any of clauses 1A-8A.

Clause 19A: A device for encoding video data, the device comprising: means for determining that a block of video data is coded using an inter-prediction-related video coding process; means for determining a minimum process grid for the inter-prediction-related video coding process; and means for deriving a motion vector for the block of video data based on the minimum process grid.

Clause 1B: A method of decoding video data, the method comprising: performing motion compensation for a block of video data using a first process grid size; determining a second process grid size for a subsequent inter-prediction-related video coding process, wherein the second process grid size is larger than the first process grid size; determining whether the block of video data has at least one sample that has a different motion vector than at least one other sample in a block of the second process grid size; in response to determining that the block of video data has at least one sample that has the different motion vector than at least one other sample in the block of the second process grid size, performing the subsequent inter-prediction-related video coding process for the block of video data using the second process grid size; and
outputting a decoded version of the block of video data.

Clause 2B: The method of clause 1B, wherein the subsequent inter-prediction-related video coding process comprises local illumination compensation.

Clause 3B: The method of clause 1B, wherein the subsequent inter-prediction-related video coding process comprises an out-of-boundary check.

Clause 4B: The method of any of clauses 1B-3B, wherein the first process grid size is 1×1.

Clause 5B: The method of any of clauses 1B-4B, wherein the second process grid size is greater than or equal to 4×4.

Clause 6B: The method of any of clauses 1B-5B, wherein performing motion compensation for the block of video data using the first process grid size comprises performing affine motion compensation for the block of video data.

Clause 7B: The method of any of clauses 1B-6B, wherein the block of video data comprises a coding block of a coding unit.

Clause 8B: The method of any of clauses 1B-7B, wherein determining the second process grid size comprise determining the second process grid size to be equal to a size of a subblock.

Clause 9B: The method of any of clauses 1B-8B, wherein determining the second process grid size for the subsequent inter-prediction-related video coding process comprises receiving one or more syntax elements in a bitstream of the video data, wherein the one or more syntax elements indicate the second process grid size.

Clause 10B: The method of any of clauses 1B-8B, wherein determining the second process grid size for the subsequent inter-prediction-related video coding process comprises determining the second process grid size for the subsequent inter-prediction-related video coding process based on a size of the block.

Clause 11B: The method of any of clauses 1B-8B, wherein determining the second process grid size for the subsequent inter-prediction-related video coding process comprises determining the second process grid size for the subsequent inter-prediction-related video coding process based on the subsequent inter-prediction-related video coding process.

Clause 12B: The method of any of clauses 1B-11B, wherein: the block of video data comprises a plurality of subblocks with a plurality of different motion vectors; performing the motion compensation for the block of video data using the first process grid size comprises predicting each of the plurality of subblocks with a corresponding motion vector of the plurality of different motion vectors; and performing the subsequent inter-prediction-related video coding process for the block of video data using the second process grid size comprises deriving a motion vector based on the plurality of different motion vectors and using the derived motion vector for the subsequent inter-prediction-related video coding process.

Clause 13B: The method of clause 12B, wherein deriving the motion vector based on the plurality of different motion vectors comprises selecting one of the plurality of different motion vectors as the derived motion vector.

Clause 14B: The method of clause 12B, wherein deriving the motion vector based on the plurality of different motion vectors comprises determining an average of two or more of the plurality of different motion vectors.

Clause 15B: The method of any of clauses 1B-8B or 10B-14B, wherein the method of decoding is performed as part of a video encoding process.

Clause 16B: A device for decoding video data, the device comprising: one or more memory units configured to store video data; one or more processors implemented in circuitry, coupled to the one or more memory units, and configured to: perform motion compensation for a block of video data using a first process grid size; determine a second process grid size for a subsequent inter-prediction-related video coding process, wherein the second process grid size is larger than the first process grid size; determine whether the block of video data has at least one sample that has a different motion vector than at least one other sample in a block of the second process grid size; in response to determining that the block of video data has at least one sample that has the different motion vector than at least one other sample in the block of the second process grid size, perform the subsequent inter-prediction-related video coding process for the block of video data using the second process grid size; and
output a decoded version of the block of video data.

Clause 17B: The device of clause 16B, wherein the subsequent inter-prediction-related video coding process comprises local illumination compensation.

Clause 18B: The device of clause 16B, wherein the subsequent inter-prediction-related video coding process comprises an out-of-boundary check.

Clause 19B: The device of any of clauses 16B-18B, wherein the first process grid size is 1×1.

Clause 20B: The device of any of clauses 16B-19B, wherein the second process grid size is greater than or equal to 4×4.

Clause 21B: The device of any of clauses 16B-20B, wherein to perform motion compensation for the block of video data using the first process grid size, the one or more processors are further configured to perform affine motion compensation for the block of video data.

Clause 22B: The device of any of clauses 16B-21B, wherein the block of video data comprises a coding block of a coding unit.

Clause 23B: The device of any of clauses 16B-22B, wherein to determine the second process grid size, the one or more processors are further configured to determine the second process grid size to be equal to a size of a subblock.

Clause 24B: The device of any of clauses 16B-22B, wherein to determine the second process grid size for the subsequent inter-prediction-related video coding process, the one or more processors are further configured to receive one or more syntax elements in a bitstream of the video data, wherein the one or more syntax elements indicate the second process grid size.

Clause 25B: The device of any of clauses 16B-22B, wherein to determine the second process grid size for the subsequent inter-prediction-related video coding process, the one or more processors are further configured to determine the second process grid size for the subsequent inter-prediction-related video coding process based on a size of the block.

Clause 26B: The device of any of clauses 16B-22B, wherein to determine the second process grid size for the subsequent inter-prediction-related video coding process, the one or more processors are further configured to determine the second process grid size for the subsequent inter-prediction-related video coding process based on the subsequent inter-prediction-related video coding process.

Clause 27B: The device of any of clauses 16B-26B, wherein: the block of video data comprises a plurality of subblocks with a plurality of different motion vectors; to perform the motion compensation for the block of video data using the first process grid size, the one or more processors are further configured to predict each of the plurality of subblocks with a corresponding motion vector of the plurality of different motion vectors; and to perform the subsequent inter-prediction-related video coding process for the block of video data using the second process grid size, the one or more processors are further configured to derive a motion vector based on the plurality of different motion vectors and use the derived motion vector for the subsequent inter-prediction-related video coding process.

Clause 28B: The device of clause 27B, wherein to derive the motion vector based on the plurality of different motion vectors, the one or more processors are further configured to select one of the plurality of different motion vectors as the derived motion vector.

Clause 29B: The device of clause 27B, wherein to derive the motion vector based on the plurality of different motion vectors, the one or more processors are further configured to determine an average of two or more of the plurality of different motion vectors.

Clause 30B: The device of any of clauses 16B-29B, wherein the device comprises a video decoder.

Clause 31B: The device of any of clauses 16B-30B, further comprising a display configured to display decoded video data.

Clause 32B: The device of any of clauses 16B-31B, wherein the device comprises one or more of a camera, a computer, a mobile device, a broadcast receiver device, or a set-top box.

Clause 33B: The device of any of clauses 16B-32B, wherein the device comprises a video encoder.

Clause 34B: A computer-readable storage medium storing instructions that when executed by one or more processors cause the one or more processors to: perform motion compensation for a block of video data using a first process grid size; determine a second process grid size for a subsequent inter-prediction-related video coding process, wherein the second process grid size is larger than the first process grid size; determine whether the block of video data has at least one sample that has a different motion vector than at least one other sample in a block of the second process grid size; in response to determining that the block of video data has at least one sample that has the different motion vector than at least one other sample in the block of the second process grid size, perform the subsequent inter-prediction-related video coding process for the block of video data using the second process grid size; and
output a decoded version of the block of video data.

Clause 35B: A device for decoding video data, the device comprising: means for performing motion compensation for a block of video data using a first process grid size; means for determining a second process grid size for a subsequent inter-prediction-related video coding process, wherein the second process grid size is larger than the first process grid size; means for determining whether the block of video data has at least one sample that has a different motion vector than at least one other sample in a block of the second process grid size; means for performing the subsequent inter-prediction-related video coding process for the block of video data using the second process grid size in response to determining that the block of video data has the at least one sample that has the different motion vector than the at least one other sample in a block of the second process grid size; and means for outputting a decoded version of the block of video data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
performing motion compensation for a block of video data using a first process grid size;
determining a second process grid size for a subsequent inter-prediction-related video coding process, wherein the second process grid size is larger than the first process grid size;
determining whether the block of video data has at least one sample that has a different motion vector than at least one other sample in a block of the second process grid size;
in response to determining that the block of video data has at least one sample that has the different motion vector than at least one other sample in the block of the second process grid size, performing the subsequent inter-prediction-related video coding process for the block of video data using the second process grid size; and
outputting a decoded version of the block of video data.

2. The method of claim 1, wherein the subsequent inter-prediction-related video coding process comprises local illumination compensation.

3. The method of claim 1, wherein the subsequent inter-prediction-related video coding process comprises an out-of-boundary check.

4. The method of claim 1, wherein the first process grid size is 1×1.

5. The method of claim 1, wherein the second process grid size is greater than or equal to 4×4.

6. The method of claim 1, wherein performing motion compensation for the block of video data using the first process grid size comprises performing affine motion compensation for the block of video data.

7. The method of claim 1, wherein the block of video data comprises a coding block of a coding unit.

8. The method of claim 1, wherein determining the second process grid size comprise determining the second process grid size to be equal to a size of a subblock.

9. The method of claim 1, wherein determining the second process grid size for the subsequent inter-prediction-related video coding process comprises receiving one or more syntax elements in a bitstream of the video data, wherein the one or more syntax elements indicate the second process grid size.

10. The method of claim 1, wherein determining the second process grid size for the subsequent inter-prediction-related video coding process comprises determining the second process grid size for the subsequent inter-prediction-related video coding process based on a size of the block.

11. The method of claim 1, wherein determining the second process grid size for the subsequent inter-prediction-related video coding process comprises determining the second process grid size for the subsequent inter-prediction-related video coding process based on the subsequent inter-prediction-related video coding process.

12. The method of claim 1, wherein:
the block of video data comprises a plurality of subblocks with a plurality of different motion vectors;
performing the motion compensation for the block of video data using the first process grid size comprises predicting each of the plurality of subblocks with a corresponding motion vector of the plurality of different motion vectors; and
performing the subsequent inter-prediction-related video coding process for the block of video data using the second process grid size comprises deriving a motion vector based on the plurality of different motion vectors and using the derived motion vector for the subsequent inter-prediction-related video coding process.

13. The method of claim 12, wherein deriving the motion vector based on the plurality of different motion vectors comprises selecting one of the plurality of different motion vectors as the derived motion vector.

14. The method of claim 12, wherein deriving the motion vector based on the plurality of different motion vectors comprises determining an average of two or more of the plurality of different motion vectors.

15. The method of claim 1, wherein the method of decoding is performed as part of a video encoding process.

16. A device for decoding video data, the device comprising:
one or more memory units configured to store video data;
one or more processors implemented in circuitry, coupled to the one or more memory units, and configured to:
perform motion compensation for a block of video data using a first process grid size;
determine a second process grid size for a subsequent inter-prediction-related video coding process, wherein the second process grid size is larger than the first process grid size;
determine whether the block of video data has at least one sample that has a different motion vector than at least one other sample in a block of the second process grid size;
in response to determining that the block of video data has at least one sample that has the different motion vector than at least one other sample in the block of the second process grid size, perform the subsequent inter-prediction-related video coding process for the block of video data using the second process grid size; and
output a decoded version of the block of video data.

17. The device of claim 16, wherein the subsequent inter-prediction-related video coding process comprises local illumination compensation.

18. The device of claim 16, wherein the subsequent inter-prediction-related video coding process comprises an out-of-boundary check.

19. The device of claim 16, wherein the first process grid size is 1×1.

20. The device of claim 16, wherein the second process grid size is greater than or equal to 4×4.

21. The device of claim 16, wherein to perform motion compensation for the block of video data using the first process grid size, the one or more processors are further configured to perform affine motion compensation for the block of video data.

22. The device of claim 16, wherein the block of video data comprises a coding block of a coding unit.

23. The device of claim 16, wherein to determine the second process grid size, the one or more processors are further configured to determine the second process grid size to be equal to a size of a subblock.

24. The device of claim 16, wherein to determine the second process grid size for the subsequent inter-prediction-related video coding process, the one or more processors are further configured to receive one or more syntax elements in a bitstream of the video data, wherein the one or more syntax elements indicate the second process grid size.

25. The device of claim 16, wherein to determine the second process grid size for the subsequent inter-prediction-related video coding process, the one or more processors are further configured to determine the second process grid size for the subsequent inter-prediction-related video coding process based on a size of the block.

26. The device of claim 16, wherein to determine the second process grid size for the subsequent inter-prediction-related video coding process, the one or more processors are further configured to determine the second process grid size for the subsequent inter-prediction-related video coding process based on the subsequent inter-prediction-related video coding process.

27. The device of claim 16, wherein:
the block of video data comprises a plurality of subblocks with a plurality of different motion vectors;
to perform the motion compensation for the block of video data using the first process grid size, the one or more processors are further configured to predict each of the plurality of subblocks with a corresponding motion vector of the plurality of different motion vectors; and
to perform the subsequent inter-prediction-related video coding process for the block of video data using the second process grid size, the one or more processors are further configured to derive a motion vector based on the plurality of different motion vectors and use the derived motion vector for the subsequent inter-prediction-related video coding process.

28. The device of claim 27, wherein to derive the motion vector based on the plurality of different motion vectors, the one or more processors are further configured to select one of the plurality of different motion vectors as the derived motion vector.

29. The device of claim 27, wherein to derive the motion vector based on the plurality of different motion vectors, the one or more processors are further configured to determine an average of two or more of the plurality of different motion vectors.

30. The device of claim 16, wherein the device comprises a video decoder.

31. The device of claim 16, further comprising a display configured to display decoded video data.

32. The device of claim 16, wherein the device comprises one or more of a camera, a computer, a mobile device, a broadcast receiver device, or a set-top box.

33. The device of claim 16, wherein the device comprises a video encoder.

34. A computer-readable storage medium storing instructions that when executed by one or more processors cause the one or more processors to:
perform motion compensation for a block of video data using a first process grid size;
determine a second process grid size for a subsequent inter-prediction-related video coding process, wherein the second process grid size is larger than the first process grid size;
determine whether the block of video data has at least one sample that has a different motion vector than at least one other sample in a block of the second process grid size;
in response to determining that the block of video data has at least one sample that has the different motion vector than at least one other sample in the block of the second process grid size, perform the subsequent inter-prediction-related video coding process for the block of video data using the second process grid size; and
output a decoded version of the block of video data.

35. A device for decoding video data, the device comprising:
means for performing motion compensation for a block of video data using a first process grid size;
means for determining a second process grid size for a subsequent inter-prediction-related video coding process, wherein the second process grid size is larger than the first process grid size;
means for determining whether the block of video data has at least one sample that has a different motion vector than at least one other sample in a block of the second process grid size;
means for performing the subsequent inter-prediction-related video coding process for the block of video data using the second process grid size in response to determining that the block of video data has the at least one sample that has the different motion vector than the at least one other sample in a block of the second process grid size; and
means for outputting a decoded version of the block of video data.
